(19) United States
(12) Patent Application Publication
(10) Pub. No.: US 2015/0267450 A1
(43) Pub. Date: Sep. 24, 2015

(54) SYNCHRONOUS MOVING DOUBLE-AXIS HINGE

(71) Applicant: Sinher Technology Inc., New Taipei City (TW)

(72) Inventor: Yung-Chang CHIANG, New Taipei City (TW)

(73) Assignee: Sinher Technology Inc., New Taipei City (TW)

(21) Appl. No.: 14/220,766

(22) Filed: Mar. 20, 2014

(51) Int. Cl. E05D 11/00; E05D 3/06

(52) U.S. Cl. CPC E05D 11/00; E05D 3/06

(57) ABSTRACT

A synchronous moving double-axis hinge comprises a support member, a first transmitting assembly and a second transmitting assembly mounted onto the support member, and a transmission element installed on the support member. The first transmitting assembly includes a first transmission shaft and a first helical gear. The second transmitting assembly includes a second transmission shaft and a second helical gear. The transmission element includes a hinge pin and a driven helical gear. The driven helical gear has a first engaging zone to engage with the first helical gear and a second engaging zone to engage with the second helical gear. The hinge pin has a third extension axis crossing with a first extension axis of the first transmission shaft and a second extension axis of the second transmission shaft. Thus the crossed helical gears can effectively amplify the contact among the gear teeth to make transmission steadier.

### FIELD OF THE INVENTION

The present invention relates to a double-axis hinge and particularly to a synchronous moving double-axis hinge that provides steady opening and closing.

### BACKGROUND OF THE INVENTION

A conventional flip electronic device such as a notebook computer, mobile phone or the like generally has a hinge to bridge a display and a body to allow the display to be opened or closed against the body, and also provide a torsional force to support and anchor the display at a desired angle after being opened. In the past, the hinge usually was a single-axis hinge with only one shaft as an axis. Although it allows the display to be flipped against the body, the display and body interfere with each other when the display has been opened at a certain angle, hence it limits use angle of the electronic device. Nowadays touch control electronic devices equipped with a keyboard and a touch screen are very popular. Aside from using the keyboard to do input as usual, flipping the screen and keyboard-attached body inversely to perform touch input also is a commonly required function. As a result, the conventional single-axis hinge no longer meets the present market requirement, so that double-axis hinges have been developed.

For instance, Taiwan patent No. 1255388 discloses a hinge structure which includes a first shaft fastened to a first frame, a first gear coupled on the perimeter of the first shaft, a second shaft fastened to a second frame and a second gear coupled on the perimeter of the second shaft. The first gear and second gear engage with each other. The first shaft and second shaft are turned in opposite directions at the same time. The gears of the hinge structure can be spur gears or bevel gears.

The aforesaid hinge structure is a double-axis hinge using the spur gears or bevel gears. However, in the event that the axes of the spur gears or bevel gears and the collaborated gears are not parallel to result in eccentricity or the gear teeth are not parallel, the teeth of the gears can only form point contact between them that tends to generate impact and friction between the gear teeth and shorten the lifespan of the spur gears or bevel gears. Hence how to improve the double-axis hinge to provide steady transmission is an issue yet to be resolved in the industry.

### SUMMARY OF THE INVENTION

The primary object of the present invention is to solve the problem of the conventional double-axis hinge that gears easily generate impact and friction between them because of tolerances.

To achieve the foregoing object, the present invention provides a synchronous moving double-axis hinge that comprises a support member, a first transmitting assembly, a second transmitting assembly and a transmission element. The support member includes a main body, a first hinge hole and a second hinge hole formed on the main body, and at least one holding portion located on the main body between the first and second hinge holes. The holding portion has an installation section. The first and second transmitting assemblies are mounted on the support member. The first transmitting assembly has a first transmission shaft hinged in the first hinge hole and a first helical gear annularly coupled on the surface of the first transmission shaft. The second transmitting assembly has a second transmission shaft hinged in the second hinge hole and a second helical gear annularly coupled on the surface of the second transmission shaft. The transmission element is installed on the holding portion of the support member, and includes a hinge pin hinged on the installation section and a driven helical gear fixedly mounted onto the hinge pin. The driven helical gear has a first engaging zone to engage with the first helical gear and a second engaging zone opposing to the first engaging zone to engage with the second helical gear. The first transmission shaft has a first extension axis, and the second transmission shaft has a second extension axis parallel with the first extension axis. The hinge pin of the transmission element has a third extension axis crossing with the first and second extension axes.

In one embodiment the first transmission shaft has a first latch portion and the first helical gear has a first coupling portion to latch on the first latch portion.

In another embodiment the first transmission shaft has a first retaining portion leaning on the first helical gear and collaborating with the support member to confine movement of the first helical gear on the first transmission shaft.

In yet another embodiment the first transmission shaft has a first fastening base.

In yet another embodiment the second transmission shaft has a second latch portion and the second helical gear has a second coupling portion to latch on the second latch portion.

In yet another embodiment the second transmission shaft has a second retaining portion leaning on the second helical gear and collaborating with the support member to confine movement of the second helical gear on the second transmission shaft.

In yet another embodiment the second transmission shaft has a second fastening base.

In yet another embodiment the first transmitting assembly includes a first torsional force generation portion run through by the first transmission shaft to provide a torsional force required by the first transmission shaft. The second transmitting assembly includes a second torsional force generation portion run through by the second transmission shaft to provide another torsional force required by the second transmission shaft.

In yet another embodiment the first helical gear, second helical gear and driven helical gear have respectively a plurality of helical teeth. The helical teeth of the first helical gear, second helical gear and driven helical gear are formed in a same helical direction.

The double-axis hinge of the invention thus formed, compared with the conventional structures, provides features as follows:

1. The invention employs crossed helical gears to overcome the problem of the spur gears or bevel gears caused by tolerance in the conventional technique. In the conventional technique, in the event that the axes of the spur gears or bevel gears and the collaborated gears are not parallel to result in eccentricity or the gear teeth are not parallel, the teeth of the gears can only form point contact between them that tends to generate impact and friction between the gear teeth and shorten the lifespan of the spur gears or bevel gears. The crossed helical gears of the invention can overcome the aforesaid flaws by providing curved teeth profile to form close contact between the gear teeth to improve the shortcoming of impact and friction that might otherwise occur.

2. The invention provides synchronous movements of two shafts through the crossed helical gears. The crossed helical gears have smaller gaps between the helical teeth to provide a shorter idle displacement. Hence before the engaged teeth separate from each other, the next set of teeth are engaged already. Thus the helical teeth of the crossed helical gears can effectively amplify the contact among the gear teeth to provide steadier transmission.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the synchronous moving double-axis hinge according to the invention.

FIG. 2 is a side view of the synchronous moving double-axis hinge according to the invention.

FIG. 3 is a cross section of the synchronous moving double-axis hinge according to the invention.

FIG. 4A is a schematic view of the invention in an operating condition.

FIG. 4B is a schematic view of the invention in another operating condition.

### DETAILED DESCRIPTION OF THE PREFERRED EMBODIMENT

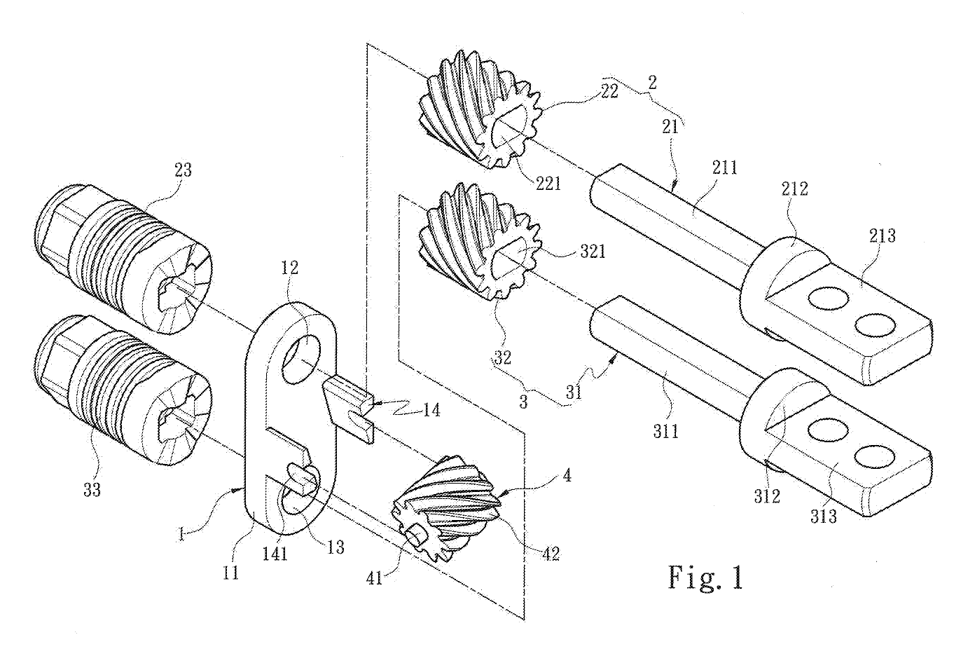

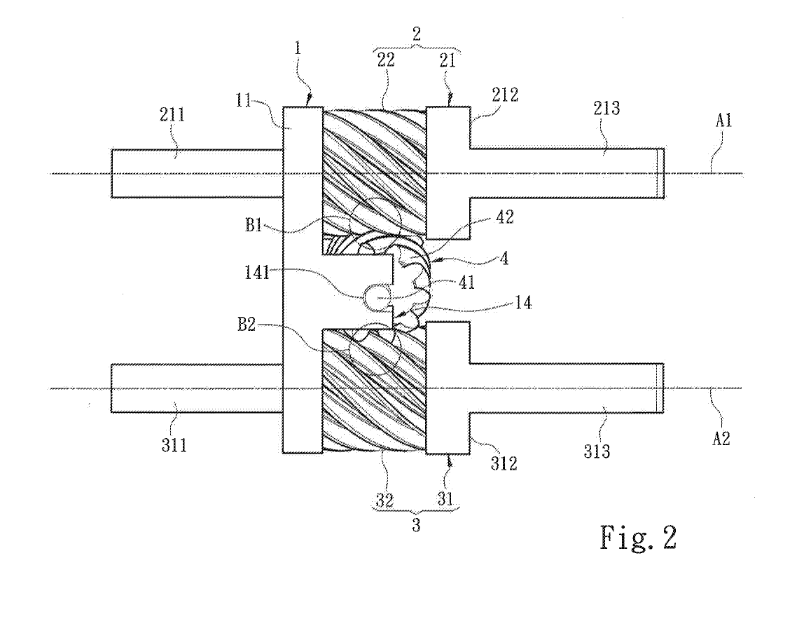

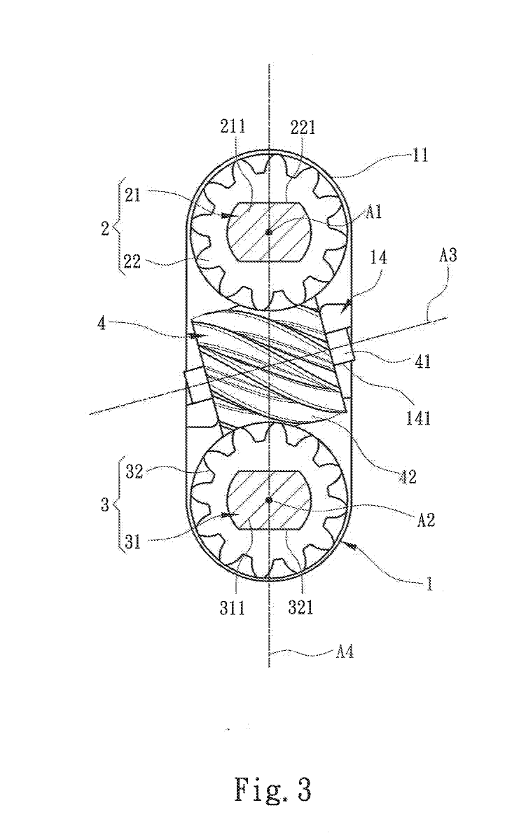

Please refer to FIG. 1, the present invention aims to provide a synchronous moving double-axis hinge that comprises a support member 1, a first transmitting assembly 2, a second transmitting assembly 3 and a transmission element 4. The support member 1 includes a main body 11, a first hinge hole 12 and a second hinge hole 13 formed on the main body 11, and at least one holding portion 14 located on the main body 11 between the first and second hinge holes 12 and 13. The holding portion 14 has an installation section 141. The first transmitting assembly 2 is mounted on the support member 1, and includes a first transmission shaft 21 hinged in the first hinge hole 12, a first helical gear 22 annularly coupled on the surface of the first transmission shaft 21 and a first torsional force generation portion 23 run through by the first transmission shaft 21 to provide a torsional force required by the first transmission shaft 21. The first transmission shaft 21 also has a first latch portion 211, a first retaining portion 212 leaning on the first helical gear 22 and collaborating with the support member 1 to confine the movement of the first helical gear 22 on the first transmission shaft 21, and a first fastening base 213 connected to the first retaining portion 212. To facilitate discussion of relative positions of the elements of the invention, the first transmission shaft 21 has a first extension axis A1 as shown in FIG. 2. The first helical gear 22 has a first coupling portion 221 latched on the first latch portion 211. The second transmitting assembly 3 is mounted on the support member 1, and includes a second transmission shaft 31 hinged in the second hinge hole 13, a second helical gear 32 annularly coupled on the surface of the second transmission shaft 31 and a second torsional force generation portion 33 run through by the second transmission shaft 31 to provide another torsional force required by the second transmission shaft 31. The second transmission shaft 31 also has a second latch portion 311, a second retaining portion 312 leaning on the second helical gear 32 and collaborating with the support member 1 to confine the movement of the second helical gear 32 on the second transmission shaft 31, and a second fastening base 313 connected to the second retaining portion 312. To facilitate discussion of relative positions of the elements of the invention, the second transmission shaft 31 has a second extension axis A2 parallel with the first extension axis A1 as shown in FIG. 2. The second helical gear 32 has a second coupling portion 321 latched on the second latch portion 311. The transmission element 4 is installed on the holding portion 14 of the support member 1, and includes a hinge pin 41 hinged on the installation section 141 and a driven helical gear 42 fixedly mounted onto the hinge pin 41. The driven helical gear 42 has a first engaging zone B1 to engage with the first helical gear 22 and a second engaging zone B2 opposing to the first engaging zone B1 to engage with the second helical gear 32. Referring to FIG. 2, in this embodiment, the hinge pin 41 and driven helical gear 42 are formed in a single element with the hinge pin 41 jutting from two ends of the driven helical gear 42. However, the hinge pin 41 and driven helical gear 42 can also be two elements with the driven helical gear 42 run through by the hinge pin 41 and fixedly mounted thereon. However, all this is not the limitation of the invention. To further facilitate discussion of the relative positions of the elements of the invention, the hinge pin 41 has a third extension axis A3 crossing with the first and second extension axes A1 and A2 as shown in FIG. 3. Also referring to FIG. 3, the first and second extension axes A1 and A2 can be represented respectively by a point, and these two points can be connected to form a reference line A4. In this embodiment, the third extension axis A3 and reference line A4 are formed a non-ninety degree included angle between them, namely the third extension axis A3 and reference line A4 are not perpendicular to each other. The included angle shown in this embodiment also is not the limitation of the invention. In addition, the first and second helical gears 22 and 32 and driven helical gear 42 have respectively a plurality of helical teeth formed thereon, and the helical teeth of the first and second helical gears 22 and 32 and driven helical gear 42 are formed in the same helical direction, such as left-hand crossed helical gears or right-hand crossed helical gears, but this is not the limitation of the invention.

To facilitate discussion of operation of the synchronous moving double-axis hinge of the invention, it is to be noted that the first transmitting assembly 2 can be driven to drive the second transmitting assembly 3, or the second transmitting assembly 3 can be driven to drive the first transmitting assembly 2, or the first and second transmitting assemblies 2 and 3 can be driven at the same time to transmit each other. The discussion below illustrates merely an instance in which the first transmitting assembly 2 is turned to drive the transmission element 4 which in turn drives the second transmitting assembly 3, but this is not the limitation of the invention. When the first transmission shaft 21 of the first transmitting assembly 2 is turned, the first helical gear 22 latched thereon is driven to drive the driven helical gear 42 of the transmission element 4; then the driven helical gear 42 further drives the second helical gear 32 of the second transmitting assembly 3 that in turn drives the second transmission shaft 31 latched thereon. Hence when the first transmitting assembly 2 is turned, the second transmitting assembly 3 also is turned accordingly.

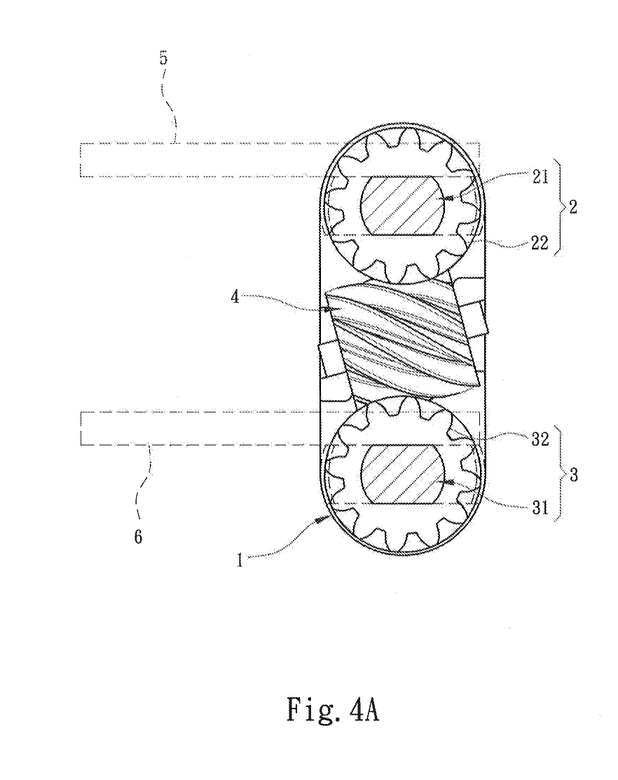

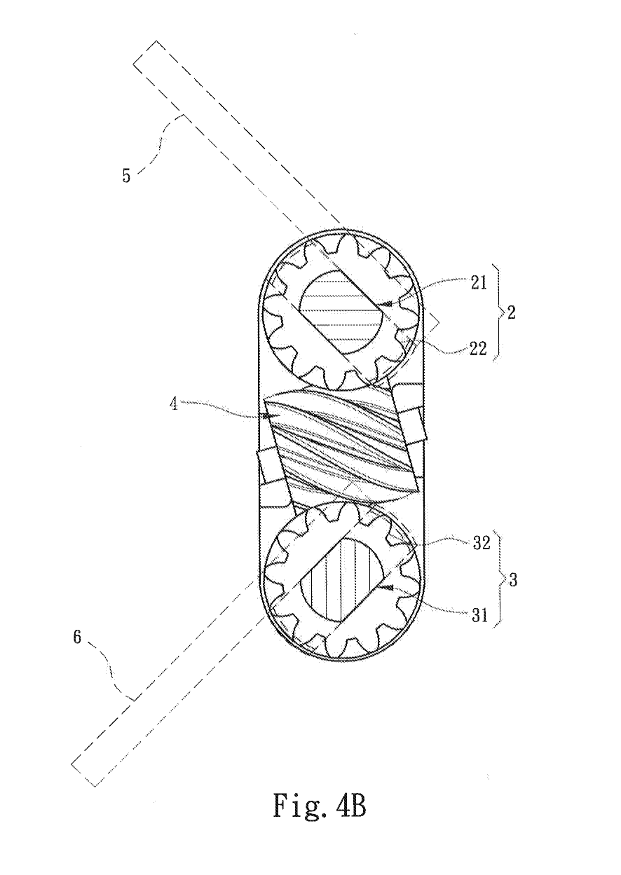

Please refer to FIGS. 4A and 4B, the first fastening base 213 of the first transmission shaft 21 is fastened to a first base 5, and the second fastening base 313 of the second transmission shaft 31 is fastened to a second base 6. When the first base 5 or second base 6 is turned by a user, the second base 6 and first base 5 are rotated at the same time due to the synchronous moving double-axis hinge. Moreover, when the first base 5 and second base 6 are turned by the user at a specific angle at the same time, the synchronous moving double-axis hinge can feedback an angle twice of the specific angle, hence the first base 5 and second base 6 can be opened or closed more rapidly.

As a conclusion, the synchronous moving double-axis hinge of the invention can provide synchronous rotation of the first transmitting assembly 2 and second transmitting assembly 3 through the transmission element 4. In addition, the first helical gear 22, second helical gear 32 and driven helical gear 42 are crossed helical gears each has a helical teeth profile formed in a curved surface. As the gap between the teeth is smaller, the crossed helical gears can contact with each other more closely. As a result, the contact among the gear teeth can be effectively amplified to provide steadier transmission.

What is claimed is:

1. A synchronous moving double-axis hinge, comprising:
a support member including a main body, a first hinge hole and a second hinge hole formed on the main body, and at least one holding portion which is located on the main body between the first hinge hole and the second hinge hole and includes an installation section;
a first transmitting assembly and a second transmitting assembly mounted on the support member, the first transmitting assembly including a first transmission shaft hinged in the first hinge hole and a first helical gear annularly coupled on a surface of the first transmission shaft; the second transmitting assembly including a second transmission shaft hinged in the second hinge hole and a second helical gear annularly coupled on a surface of the second transmission shaft; and
a transmission element which is installed on the holding portion of the support member and includes a hinge pin hinged on the installation section and a driven helical gear fixedly mounted onto the hinge pin, the driven helical gear including a first engaging zone to engage with the first helical gear and a second engaging zone opposing to the first engaging zone to engage with the second helical gear;
wherein the first transmission shaft includes a first extension axis, the second transmission shaft includes a second extension axis parallel with the first extension axis, and the hinge pin of the transmission element includes a third extension axis crossing with the first extension axis and the second extension axis.

2. The synchronous moving double-axis hinge of claim 1, wherein the first transmission shaft includes a first latch portion, and the first helical gear includes a first coupling portion latched on the first latch portion.

3. The synchronous moving double-axis hinge of claim 1, wherein the first transmission shaft includes a first retaining portion leaning on the first helical gear and collaborating with the support member to confine movement of the first helical gear on the first transmission shaft.

4. The synchronous moving double-axis hinge of claim 1, wherein the first transmission shaft includes a first fastening base.

5. The synchronous moving double-axis hinge of claim 1, wherein the second transmission shaft includes a second latch portion, and the second helical gear includes a second coupling portion latched on the second latch portion.

6. The synchronous moving double-axis hinge of claim 1, wherein the second transmission shaft includes a second retaining portion leaning on the second helical gear and collaborating with the support member to confine movement of the second helical gear on the second transmission shaft.

7. The synchronous moving double-axis hinge of claim 1, wherein the second transmission shaft includes a second fastening base.

8. The synchronous moving double-axis hinge of claim 1, wherein the first transmitting assembly includes a first torsional force generation portion run through by the first transmission shaft to provide a torsional force required by the first transmission shaft, and the second transmitting assembly includes a second torsional force generation portion run through by the second transmission shaft to provide another torsional force required by the second transmission shaft.

9. The synchronous moving double-axis hinge of claim 1, wherein the first helical gear, the second helical gear and the driven helical gear include respectively a plurality of helical teeth, the plurality of helical teeth of the first helical gear, the second helical gear and the driven helical gear being formed in a same helical direction.
